(19) United States
(12) Patent Application Publication
(10) Pub. No.: US 2013/0242688 A1
(43) Pub. Date: Sep. 19, 2013

(54) PILL PREPARATION, STORAGE, AND DEPLOYMENT SYSTEM FOR WELLBORE DRILLING AND COMPLETION

(71) Applicant: Paul Leon Kageler, Lake Jackson, TX (US)

(72) Inventor: Paul Leon Kageler, Lake Jackson, TX (US)

(21) Appl. No.: 13/887,849

(22) Filed: May 6, 2013

Related U.S. Application Data
(63) Continuation-in-part of application No. 13/416,767, filed on Mar. 9, 2012.

(51) Int. Cl. B01F 7/00

(52) U.S. Cl. CPC B01F 7/00233
USPC 366/139; 366/292; 366/144; 366/182.2

(57) ABSTRACT

Systems and methods for preparation, storage, and/or deployment of a specialized fluid are disclosed. A system for preparation, storage, and/or deployment of a specialized fluid comprises a fluid vessel, a first, second, and third agitation unit, wherein each of the agitation units is at least partially disposed within the fluid vessel, a first, second, and third motor coupled to each of the agitation units, respectively, wherein each of the motors are independently operable. A method for preparing, storing, and/or deploying one or more specialized fluids comprises mixing a first specialized fluid in a first fluid vessel using any combination of a first, second, and third agitation unit and removing the first specialized fluid from the first fluid vessel.

### CROSS-REFERENCE TO RELATED APPLICATION

This application is a continuation-in-part of U.S. patent application Ser. No. 13/416,767, which was filed Mar. 9, 2012 and is hereby incorporated by reference in its entirety.

### BACKGROUND

The present disclosure relates generally to subterranean drilling and completion operations and, more particularly, to a method and apparatus for preparing, storing, and/or deploying a pill. The term “pill” as used herein refers to a batch of specialized fluid used to serve a particular function during drilling and/or completion operations.

Drilling and completion operations play an important role when developing oil, gas or water wells or when mining for minerals and the like. During drilling operations, a drill bit passes through various layers of earth strata as it descends to a desired depth. Drilling fluids are commonly employed during the drilling operations and perform several important functions including, but not limited to, removing the cuttings from the well to the surface, controlling formation pressures, sealing permeable formations, minimizing formation damage, and cooling and lubricating the drill bit. When performing drilling operations in a reservoir, it is desirable to use special fluids that minimize damage to the formation. During subsequent completion operations, steps may be taken to enhance well productivity and additional downhole equipment may be installed.

When the drill bit passes through porous, fractured or vugular strata such as sand, gravel, shale, limestone and the like, the hydrostatic pressure caused by the vertical column of drilling fluid may exceed the ability of the surrounding earth formation to support this pressure. As a result, fluid communication with the surrounding formation may occur immediately in an open hole and after the perforation step for a cased wellbore. Once there is fluid communication between the wellbore and the formation, the hydrostatic pressure caused by the drilling fluid or a completion fluid may exceed the pore pressure of the earth formation. Consequently, some drilling or completion fluid may be lost to the formation and may fail to return to the surface. During drilling operations, the general practice is to add any number of fluid loss control materials to the drilling fluid which act to form a wellbore filter cake that reduces the loss of fluid to the formation.

To help optimize or maintain drilling and completion operations, it may be necessary to prepare and then pump one or more pills down hole. These pills are usually made or built in a step-by-step batch process at the drill site. The composition and rheology of pills may vary considerably and may be complex in nature, making it difficult to prepare, store, and deploy these pills on the surface using standard fluid processing equipment. In some cases, such as in the case of displacement pills, it may be desirable to sequentially pump a series of specialized pills downhole without pausing. It is therefore advantageous to be able to prepare and then sequentially pump multiple pills downhole.

Some examples of pills include, but are not limited to, Loss Control Material (LCM), barriers, sweeps, spacers, cleaners, push, wetting agents, lubricants, and thermal insulations. To improve downhole performance, pills may be highly viscous and/or highly thixotropic in nature. Such pills may also be formulated with high concentrations of solids to increase fluid density and/or to cause bridging once downhole. The term “thixotropic” as used herein refers to a shear thinning property of a fluid. Accordingly, highly thixotropic materials are thick (viscous) under static conditions and become thinner (or less viscous) when shaken, agitated, pumped, or otherwise exposed to a sufficient shear stress. Thus, highly thixotropic pills may form semisolids or gels under static conditions in a vessel that must be broken by applying a shear stress before discharging from the vessel. Some highly thixotropic mixtures isolate fluid motion in a vessel and prevent the desired formation of a homogenous mass unless a combination of multiple agitation units equipped with custom impellers are employed.

In some cases, standard blending and mixing systems commonly utilized at rig sites cannot build and handle pills that possess desired downhole properties such as high viscosity, high suspension capability, high density, gel formation under static conditions, bridging capabilities, and/or thermal isolation. These standard drill site blending and mixing systems typically include a vessel equipped with a single agitator unit, a discharge/circulation pump, hatches or an open deck for adding materials, and an inline hopper to add powders to a high-shear zone. Many powders used to prepare pills tend to quickly encapsulate, forming “fish eyes” if the powder and surrounding fluid does not quickly enter into a high-shear zone. As used herein, “fish eyes” are encapsulated gelled particles that may result in yield loss, plugging of surface equipment such as pump suction strainers, and plugging of the reservoir formation resulting in lower permeability.

With respect to certain pill formulations, some of the common deficiencies observed when utilizing standard drilling rig site blending and mixing systems include, but are not limited to, an inability to evenly blend larger quantities of highly thixotropic fluids, an inability to completely break down large quantities of gel into a free-flowing fluid, an inability to provide high intensity microshear when adding powders that are prone to form fish eyes, an inability to provide a variety of different mixing actions simultaneously, an inability to adequately discharge the vessel due to pump limitations, an inability to adequately discharge the vessel due to vessel configuration, an inability to create and discharge a homogeneous fluid, an inability to provide gentle agitation during storage to prevent the settling of solids, an inability to discharge high-viscosity sludge and slurries by pumping, an inability to reduce fluid viscosity by heating the fluid, and an inability to avoid freezing of some fluids during long-term storage.

Standard rig site blending equipment is also limited as to the turn-down ratio of the pill batch size that can be prepared and deployed without compromising downhole pill performance. The term “turn-down ratio” refers to the maximum pill volume divided by the minimum pill volume that can be effectively blended and mixed in a system. Typically, pills of smaller size as related to the vessel total volume may not be able to be prepared and deployed by standard equipment because of critical agitator impellers that sit above the fluid level, resulting in inadequate mixing and poor drainage from the bottom of the vessel.

Standard mobile blending equipment typically rented for special applications may have only one agitated vessel and may require considerable drill site deck space or drill site ground space to operate. Limitation in drill site deck space or ground space may make it impractical to prepare, store, and deploy multiple pills in an optimized sequence.

Additionally, thixotropic fluids having thick slurry, high viscosity, high concentration of solids, and/or those that can form a semisolid mass under static conditions, may remain in a semisolid state and withstand motion unless several different mixing actions are applied simultaneously using the correct combination of impellers rotated at different speeds.

Thus, it is desirable to have a mobile integrated blending and mixing system for eliminating common deficiencies observed with standard drilling rig site blending systems discussed above.

Drilling operations for oil and gas continue to become more challenging as easy to extract hydrocarbons become more difficult to find or access. For example, drilling operations such as ultra-deep water, high pressure high temperature, drilling to great depths, long reach horizontal drilling through fractured shale, managed pressure drilling, underbalanced drilling, and drilling through reactive shale may increase the need for more specialized pills, more frequent pumping of pills, high volumes of pills that may exceed the limited number of suitable agitated pits, pit capabilities with respect to fluid thickness and gel strength, and limited availability of rig contractor personnel to operate and clean the pill pits. In addition, the high cost of drilling and completing wells may help justify additional steps to maximize recovery of hydrocarbons by using additional pills and special fluid systems designed to prevent damage to pay zones and more complete removal of well bore filter cake. It is therefore advantageous to bring out integrated mobile pill preparation, storage, and deployment systems that overcome traditional drill site limitations.

### SUMMARY

Systems and methods for preparation, storage, and/or deployment of a specialized fluid are disclosed. A system for preparation, storage, and/or deployment of a specialized fluid comprises a fluid vessel, a first, second, and third agitation unit, wherein each of the agitation units is at least partially disposed within the fluid vessel, a first, second, and third motor coupled to each of the agitation units, respectively, wherein each of the motors are independently operable. A method for preparing, storing, and/or deploying one or more specialized fluids comprises mixing a first specialized fluid in a first fluid vessel using any combination of a first, second, and third agitation unit and removing the first specialized fluid from the first fluid vessel.

The features and advantages of the present invention will be apparent to those skilled in the art from the description of the preferred embodiments which follows when taken in conjunction with the accompanying drawings. While numerous changes may be made by those skilled in the art, such changes are within the spirit of the invention.

### BRIEF DESCRIPTION OF THE DRAWINGS

These drawings illustrate certain aspects of some of the embodiments of the present invention, and should not be used to limit or define the invention.

FIG. 1 depicts a mobile integrated pill preparation, storage, and deployment system configured for a single vessel in accordance with an illustrative embodiment of the present disclosure.

FIG. 2 depicts a mobile single vessel modular skid as transported to the drill site for integration into preparing, storing, and/or deploying the mobile integrated pill preparation, storage and deployment system of FIG. 1.

FIG. 3 depicts a mobile pill preparation, storage, and deployment system configured for a single vessel in accordance with an illustrative embodiment of the present disclosure.

FIG. 4 depicts a front view of a three-vessel system for preparing, storing, and/or deploying pills in accordance with an illustrative embodiment of the present disclosure.

FIG. 5 depicts a mobile power and pump skid for preparing, storing, and/or deploying pills in accordance with an illustrative embodiment of the present disclosure.

FIG. 6 depicts a flow chart for preparing, storing, and/or deploying pills in accordance with an illustrative embodiment of the present disclosure.

While embodiments of this disclosure have been depicted and described and are defined by reference to example embodiments, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure relates generally to subterranean drilling and completion operations and, more particularly, to a method and apparatus for preparing, storing, and/or deploying pills that may be thixotropic in nature.

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present disclosure, the following examples of certain embodiments are given. In no way should the following examples be read to limit, or define, the scope of the disclosure. Embodiments of the present disclosure may be applicable to horizontal, vertical, deviated, or otherwise nonlinear wellbores in any type of subterranean formation. Embodiments may be applicable to injection wells as well as production wells, including hydrocarbon wells.

The present disclosure is directed to a system and method for preparing, storing, and/or deploying pills including, but not limited to, difficult to handle pills. The difficult to handle pills may include one or more of the following: a viscous sludge, a slurry, a semisolid fluid, a highly viscous fluid, and a thixotropic fluid.

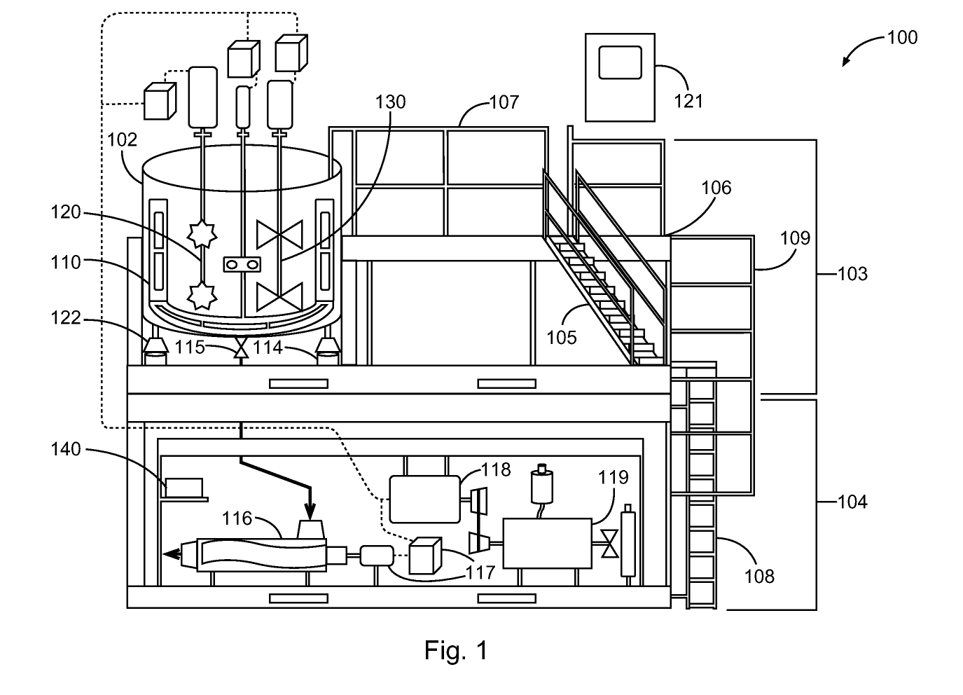

Turning now to FIG. 1, a mobile single-vessel integrated system for preparing, storing, and/or deploying a pill in accordance with an illustrative embodiment of the present disclosure is denoted generally with reference number 100. The system 100 includes a fluid vessel 102. The fluid vessel 102 may be configured to monitor temperature, pressure, fluid level, and/or fluid weight. The fluid vessel 102 may be made of any suitable materials, including, but not limited to, hard plastic, metal, or any other sufficiently robust material. The fluid vessel 102 may have any suitable geometry. For instance, in certain embodiments, the fluid vessel 102 may be generally cylindrical, have a dished bottom, and may be accessible through at least one opening (not shown). In other embodiments, the bottom section of the fluid vessel 102 may be conical in shape instead of dished to facilitate a more complete discharge of a viscose fluid. The fluid vessel 102 may be a multiple purpose vessel that may function as an agitated batch reactor, a temporary storage vessel, a blending vessel, a dilution vessel, and/or a heating or cooling device.

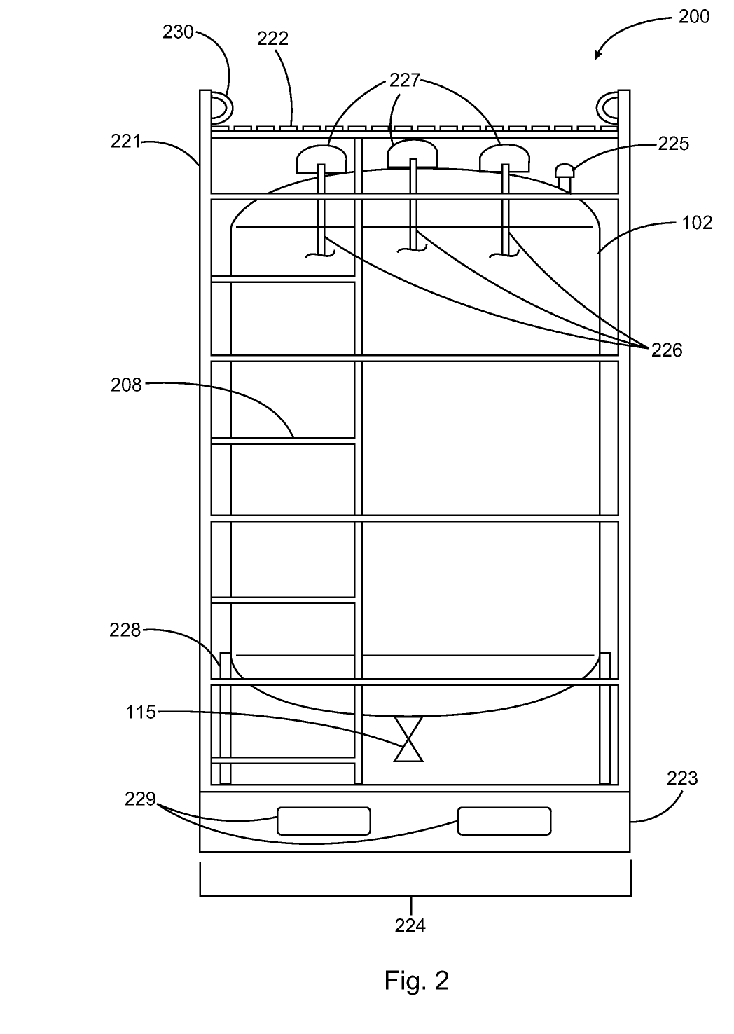

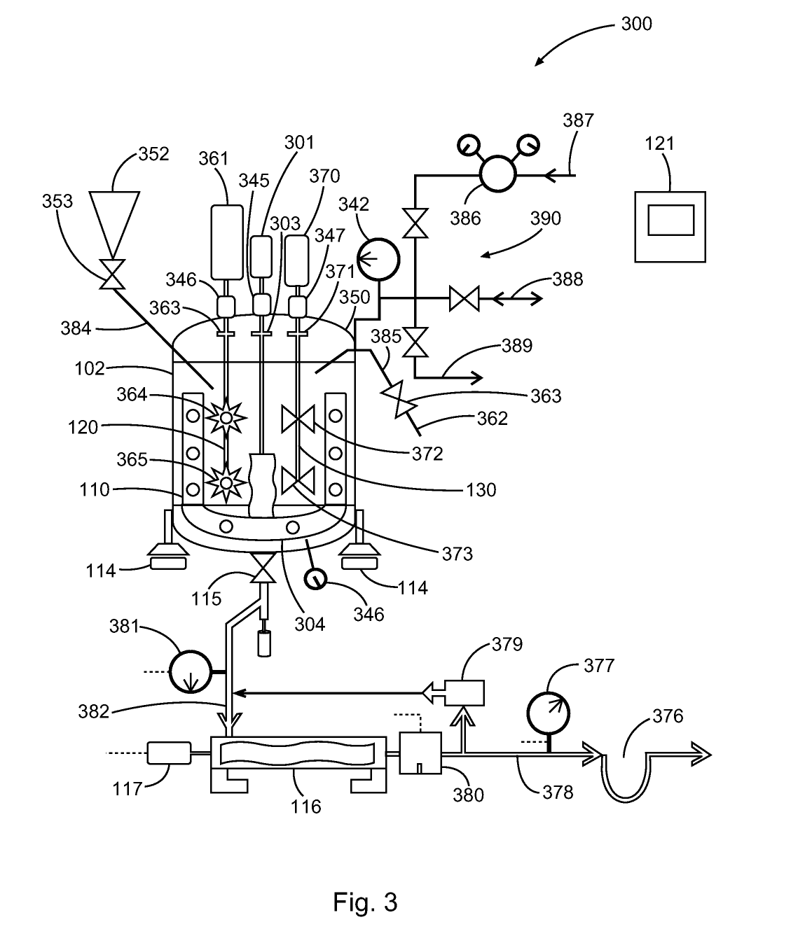

For safe transportation, lifting, and access to heights, the fluid vessel 102 may be incorporated inside a modular vessel skid as discussed in greater detail with respect to FIG. 2. The fluid vessel 102 may be couplable to an operating skid 103 for transportation. The fluid vessel 102 and operating skid 103 may be transported coupled together or independently. Additionally, the fluid vessel 102 may be coupled to a pump and power skid 104, a safe access ramp 105, a safe access platform 106, a set of hand rails 107, a safe access ladder 108, a ladder safety cage 109, and a control panel 121. As would be appreciated by those of ordinary skill in the art, with the benefit of the present disclosure, the control panel 121 may be communicatively coupled to the system through a wired or wireless connection. Structure and operation of such connection systems is well known to those of ordinary skill in the art, having the benefit of the present disclosure and will therefore not be discussed in detail herein. Similarly, a pump 116, a pump drive 117, a generator 118, a reciprocating engine 119, batteries 140, and related components may be mounted to the pump and power skid 104 for transportation. The control panel 121 may be contained in a sealed box designed to hold all components that require isolation from a potentially hazardous environment. The function of the control panel 121 is discussed in further detail with respect to FIG. 3. The operating skid 103 and pump and power skid 104 may be designed for safe lifting with a fork lift or crane. Further, the operating skid 103 and the pump and power skid 104 may be transported by any suitable means typically used for transport of such components. For instance, these components may be safely transported by truck, rail, air or marine vessels such as a boat or barge. The safe access ramp 105, safe access platform 106, hand rails 107, safe access ladder 108, and ladder safety cage 109 may be designed to provide access to the fluid vessel 102. The fluid vessel 102 may further include one or more of a first agitation unit 110, a second agitation unit 120, and a third agitation unit 130, each capable of different mixing actions. The agitation units 110, 120, and 130 may include variable speed controllers for adjusting the rotational speed of the agitator shafts. The function and operation of each of the agitation units 110, 120, and 130 is discussed in further detail with respect to FIG. 3.

As shown in FIG. 1, the fluid vessel may be coupled to the pump 116 for discharge of fluid. The fluid vessel 102 may be supported by feet 122 that may be mounted on top of strain gauge load cells 114. The weight of the content in the fluid vessel 102 may be continuously monitored by totaling the force exerted on each of the load cells 114. In certain implementations, four load cells may be used. The fluid vessel 102 may include a bottom vessel discharge valve 115. The bottom vessel discharge valve 115 may be a ram type of valve suited for high viscosity fluids that may contain solids. The bottom vessel discharge valve 115 may be coupled to the pump 116 by piping, flexible hose, or any other conduit known to those of skill in the art having the benefit of this disclosure. The material discharged through valve 115 may flow to the pump 116 that transfers this material to the next location through piping or flexible hose. The pump 116 may be a progressing cavity pump capable of transferring high-viscosity fluids that contain solids. The pump 116 may be coupled to the pump drive 117. The pump drive 117 may include an electric motor/variable speed controller that allows for the fluid discharge rate from the fluid vessel 102 to be varied and controlled. The power from the generator 118 may be coupled to the pump drive 117 and to the first, second, and third agitation units 110, 120, 130. The generator 118 may provide the power for all the agitation units 110, 120, and 130 and the pump 116. The generator 118 may be designed for operation in hazardous locations. The generator 118 may be coupled to and powered by a reciprocating engine 119 that may be designed for operation in hazardous locations. The reciprocating engine 119 may use any suitable fuels including, but not limited to, diesel, gasoline, or natural gas fuel. Batteries 140 may be used to start reciprocating engine 119 and to provide backup power for critical instrumentation and lighting systems.

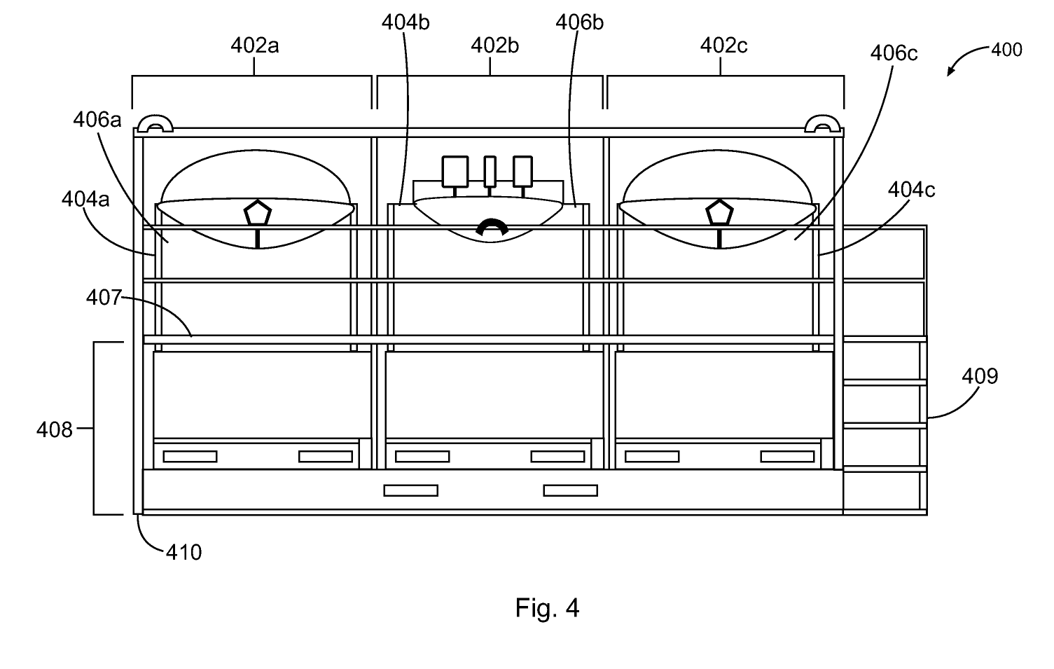

Turning now to FIG. 2, a mobile single-vessel system for preparing, storing, and/or deploying in accordance with an illustrative embodiment of the present disclosure is depicted generally with reference numeral 200. In certain embodiments, the mobile single-vessel system 200 may be used to house and/or transport the fluid vessel 102 of FIG. 1. The system 200 is shown in FIG. 2 in the form that it could be transported to a drilling site. A modular vessel skid 224 may include the fluid vessel 102 mounted inside a protective frame 221. The protective frame 221 may be made of steel or any other strong material known to those of skill in the art having the benefit of this disclosure. The protective frame 221 may be covered by a removable grid platform 222, and may be mounted on a base 223. In certain implementations, the base 223 may be designed to accommodate fork truck lifts. The fluid vessel 102 may include the bottom discharge valve 115 as discussed above in conjunction with FIG. 1. Additionally, the fluid vessel 102 may include a vent valve 225, one or more lower agitator assemblies 226, one or more removable protective caps 227, and support legs 228. The base 223 may include slots 229 to accommodate prongs of a fork lift or other mechanism that may be used to move the system 200. The protective frame 221 may be coupled to the base 223 and may include crane lift eyes 230 and a safe access ladder 208. Once the system 200 has arrived at the drill site, the modular vessel skid 224 may be mounted on a mobile single vessel integrated system 100 depicted in FIG. 1 or it may be mounted on a three-vessel system 400 as depicted in FIG. 4. The fluid vessel 102 may be transported to the drill site empty or with one or more fluids inside.

Turning now to FIG. 3, a system for preparing, storing, and/or deploying a pill in accordance with an illustrative embodiment of the present disclosure is denoted generally with reference numeral 300. The system 300 includes the fluid vessel 102. A weight of a fluid contained in the fluid vessel 102 may be measured by one or more load cells 114 coupled to the fluid vessel 102.

In the embodiment shown in FIG. 3, a funnel 352 is coupled to a full port valve 353 that connects to feed line 384 for transferring materials prone to form fish eyes into a high shear zone within the fluid vessel 102. The preferred zone to introduce additive materials that may form fish eyes is near a top impeller 364. Additional openings may be incorporated into the fluid vessel 102. In some embodiments, such as the one shown in FIG. 3, the fluid vessel 102 may be a closed vessel that may be isolated from the atmosphere. However, in other embodiments, the top of the fluid vessel 102 may be open to the atmosphere and covered with a grid work deck (not shown). In the embodiment shown in FIG. 3, a fluid addition line 362 is coupled to a valve 363, which may be coupled to a feed line 385 that continues past the wall of the fluid vessel 102. The valve 363 may be used to regulate and shut off fluid flow through the fluid addition line 362. The valve 363 may be of any suitable design including, but not limited to, a ball, plug, gate, butterfly, pinch, or needle configuration. The fluid addition line 362 may be used to add liquid, fluid, gel, sludge, or slurry components to the fluid vessel 102, while the funnel 352 may be used to add powders, solids, or dry components to the fluid vessel 102. Materials, including solids, that are not prone to cause fish eyes may be added through quick open hatch 350.

In certain embodiments, the specialized fluid may be prepared in the fluid vessel 102 located at a drilling site. In other embodiments, the specialized fluid may be prepared in the fluid vessel 102 located off-site and then the fluid vessel 102 may later be transported to a drilling site. Thus, the system 100 is mobile such that the fluid vessel 102 may be transported to a drilling site once the specialized fluid is prepared within it or moved empty.

Thus, in certain embodiments, the system 300 may be mobile and mounted to one or more skids as shown in FIGS. 1 and 2 to facilitate transportation to and from land and offshore drill sites. The system 300, when mounted to the skids as discussed herein, may be designed and certified for ground and/or marine transport when the fluid vessel 102 is empty. The skids may facilitate easy transport, set-up, and rig down. Once at the drill site, the system 300 may be set up and may be used for preparing, storing, and/or deploying pills. When no longer needed, the system 300 may be cleaned, rigged down, and transported to another location. The described configuration is advantageous because it provides quick set-up, allows the system 300 to occupy minimum ground or deck space at the drill site, allows safe lifting by a fork lift or a crane, allows the system 300 to meet all air, truck, and marine transport requirements, and allows safe access to heights. The various skids depicted in FIGS. 1, 2, 4, and 5 function to facilitate modular lifting, transportation, set-up, and rig-down of one or more systems 300.

Still referring to FIG. 3, the system 300 may further include the first agitation unit 110 that is at least partially disposed in the fluid vessel 102. The first agitation unit 110 may include a first motor 301, a shaft coupler 303 coupled to the first motor 301, and an impeller 304 coupled to the shaft coupler 303. In certain embodiments, the first agitation unit 110 may be a bulk blender. The impeller 304 may include a variety of configurations and may be capable of creating fluid movement throughout the fluid vessel 102 even when the fluid in the fluid vessel 102 is of a high viscosity. Fluid movement is created throughout the fluid vessel 102 when the impeller 304 is rotated. The shape, length, and positioning of the impeller 304 as well as the number of impellers attached to the shaft coupler 303 may be varied without departing from the scope of the present disclosure. Moreover, any number of impellers 304 may be used without departing from the scope of the present disclosure. The one or more impellers 304 may have a large combined surface area, may be designed to prevent any static zones within the fluid vessel 102, may increase heat transfer into the fluid vessel 102, and/or may primarily provide macro-scale blending. The impeller 304 may be of a design that includes holes, slots, and/or screens that may reduce power consumption. The illustrative impeller 304 depicted in FIG. 3 is shown with holes.

Still referring to FIG. 3, the system 300 may further include the second agitation unit 120 that is at least partially disposed in the fluid vessel 102. The second agitation unit 120 may include a second motor 361, a shaft coupler 363 coupled to the second motor 361, and an upper and lower impeller 364 and 365 coupled to the shaft coupler 363. In certain embodiments, the second agitation unit 120 may be a homogenizer. The second motor 361 may provide power to the second agitation unit 120. The upper and lower impellers 364 and 365 may be smaller in size compared to the impeller 304 of the first agitation unit 110, and they may be rotated at speeds sufficient to provide intense high-shear zones near the impellers 364, 365 for quickly homogenizing materials that are prone to cause fish eyes. High intensity shear zones may also rapidly eliminate suspended gelled particles and drastically reduce apparent viscosity of highly thixotropic fluids. In FIG. 3, the upper impeller 364 and the lower impeller 365 may be identical and of a rotor-stator type, where the outside rotor has teeth that create high shear when rotated around a stationary inter-stator that has slots. The upper and lower impellers 364 and 365 may include a variety of configurations. The present disclosure is not limited to a specific number of impellers, rotor teeth, stator slots, diameter, shape, or positioning of impellers, or length of rotor teeth. For example, the number and the diameter of the upper and lower impellers 364 and 365, the number and length of the rotor teeth, and/or the number of stator slots may be varied within the scope of the present disclosure.

Still referring to FIG. 3, powders or liquids that are prone to encapsulate and form fish eyes when added into a fluid in a low-shear zone may be added directly to a high-shear zone created by rotating upper impeller 364. The funnel 352 in conjunction with the valve 353 and feed line 384 may be used to transfer powders and liquids directly into the fluid vessel 102 near the upper impeller 364. The capability to directly add certain powders and liquids to a high-shear zone inside of the fluid vessel 102 reduces or eliminates the formation of undesired fish eyes. The ability to add powders and liquids with encapsulating tendencies directly to the fluid vessel 102 without causing excessive fish eye formation eliminates the need for a separate inline hopper/blender and thus greatly simplifies the system 300 and results in skid systems that are easier to transport, easier to set up, and require less ground or deck space at the drill site.

Still referring to FIG. 3, the system 300 may further include the third agitation unit 130 mounted such that it is at least partially disposed in the fluid vessel 102. The third agitation unit 130 may include a third motor 370, a shaft coupler 371 coupled to the third motor 370, and upper and lower impellers 372 and 373 coupled to the shaft coupler 371. In certain embodiments, the third agitation unit 130 may be a dispersion mixer. The upper and lower impellers 372 and 373 may be of a variety of configurations. For example, the upper and lower impellers 372 and 373 may be identical and shaped to create a dispersion mixing action as shown in FIG. 3. The third agitation unit 130 may be designed to create moderate shear zones as well as rapid radial and vertical acceleration of fluid within the fluid vessel 102. The impellers 372 and 373 may be an angled turbine type, a hydrofoil type, or any other impeller type known to those of skill in the art having the benefit of this disclosure. The shear zones may become smaller as the apparent viscosity of the fluid increases. The present disclosure is not limited to a specific number of impellers, impeller style, diameter of impellers, or shape, length, or positioning of the impellers. For example, the number and diameter of the impellers and/or the design of the impellers may be varied.

Each agitation unit 110, 120, and 130 may include a first, second, and third agitator seal 345, 346, and 347. The agitator seals 345, 346, and 347 may each function as a barrier assembly located where each agitation unit passes through the wall fluid vessel 102. Each agitator seal 345, 346, 347 may allow the respective shaft coupler 303, 363, and 371 to rotate without allowing materials to leak out of or into the fluid vessel 102 even when the fluid vessel 102 is operated at positive or negative pressures with respect to ambient pressures.

As described above, the first agitation unit 110, the second agitation unit 120, and the third agitation unit 130 each include a separate shaft coupler (303, 363, and 371, respectively), and are each coupled to a separate motor (301, 361, and 370, respectively). Therefore, the first, second, and third agitation units 110, 120, and 130 may be controlled independently. The first, second and third motors 301, 361, and 370 may be any suitable type of motor such as, for example, electric, hydraulic, pneumatic, or of any other type known to those in the art having the benefit of this disclosure. An electric motor with an acceptable hazardous zone classification is preferred. The first, second, and third agitation units 110, 120, and 130 may also be directly coupled to a reciprocating diesel, gasoline, or natural gas engine. The first, second, and third motors 301, 361, and 370 may be capable of operating at variable speeds. Options for providing variable speed agitations include, but are not limited to, variable frequency drives (VFD), variable speed DC motors, gear couplers, pulleys/belts, and hydraulic or pneumatic speed control devices.

Thus, in operation of the system 300, the first, second, and third agitation units 110, 120, and 130 may be operated independently, such that they may be run one at a time, concurrently, or in any combination. For maximum blending and mixing intensity, all three agitation units 110, 120, and 130 may be operated concurrently at maximum rotational speed settings. Operation of all three agitation units 110, 120, and 130 concurrently creates a triple action agitation system within a single fluid vessel 102. It is advantageous to have triple action within the fluid vessel 102 as it may create significant synergies with regards to blending and mixing over a wide range of apparent viscosities and solid concentrations. Triple action mixing capability allows for preparing, storing, and/or deploying a wide range of difficult to handle fluid compositions. Triple action agitation systems within a single fluid vessel 102 may also reduce or eliminate the need to use several different vessels or unit operations when processing or blending complex compositions, resulting in simplicity of operation and reduced equipment-related costs. The system 100 provides greater flexibility at the drill site to prepare, store, and deploy a wide range of different types of pills in an optimal manner without the disadvantages of additional specialized equipment as compared to previous systems in the art.

In further operation of the system 100, the first, second, and third agitation units 110, 120, and 130 may provide different blending and mixing actions that may include high-shear homogenizing, dispersion mixing, and slow-speed blending. The first, second, and third agitation units 110, 120, and 130 may be configured to operate at variable speeds. The first, second, and third agitation units 110, 120, and 130 may be equipped with a soft-start feature to help prevent excessive stress that may form on each agitation unit 110, 120, and 130 when breaking a gel. The impellers on each agitation unit 110, 120, and 130 may be custom-designed to achieve each different type of mixing action. For example, the upper and lower impellers 372 and 373 on the third agitation unit 130 may be disposed at an angle in order to achieve dispersion mixing. The upper and lower impellers 364 and 365 on the second agitation unit 120 may be configured as a rotor-stator in order to provide homogenization. The impeller 304 on the first agitation unit 110 may be configured as an anchor in order to provide bulk blending.

The control panel 121 may include an interface to couple with the first, second, and third agitation units 110, 120, and 130, each of which may have variable speed and programmable capabilities. For alternating electric powered systems, the variable speed drives may change the frequency of the currents that feed the first, second, and/or third motors 301, 361, and 370 and thus control the rotational output of each motor. Such drives may be referred to as a variable frequency drive (VFD). The control panel 121 may be communicatively coupled to the VFDs (not shown) that control the rotational speeds of the agitation units through a wired or wireless communication network. In order to meet hazardous area ratings, three separate VFDs may be used to control the rotational speeds of the first, second, and third motors 301, 361, and 370 and the pump drive 117. These VFDs may be housed in sealed boxes that are rated for hazardous locations that are mounted on a skid (not shown), located in a modular building rated for hazardous locations (not shown), or located in an area outside of the hazardous location. Locating the VFDs in a modular building rated for hazardous locations or in areas outside of the hazardous zone may offer many design, operational, cost, and maintenance advantages especially when more than one skid system is operated inside of the same hazardous area. The control panel 121 may be a programmable logic controller (PLC) or any other type of automatic control system known to those in the art having the benefit of this disclosure. The control panel 121 may provide a user interface permitting a user to manipulate the operation of the first motor 301, the second motor 361, and the third motor 370. For instance, a user may set the control panel 121 such that the variable speed drive in the first motor 301 may operate the first agitation unit 110 at variable speeds and may automatically change the speed over time. When exposed to static conditions, some fluids may form strong gels that may stress mechanical components if any of the agitation units are started-up abruptly. For this reason, the agitation units 110, 120, and 130 may be programmed to increase their rotational speeds slowly during their initial start-up in order to prevent excessive stress on mechanical components. When preparing pills, the mixing action and intensity of the mixing provided by each agitation unit may be varied throughout the preparation process. For example, maximum mixing intensity of all three agitation units may be needed when adding powders that may form fish eyes or when shearing highly thixotropic pills before discharging them from the fluid vessel 102. The first agitation unit 110 may be operated at low speeds over extended time periods when storing pills that may experience the slow settling of solids such as barite or when heat transfer to prevent freezing is advantageous.

The rotational shaft speeds of the first, second, and third agitation units 110, 120, and 130 may each be communicated to the control panel 121 via an interface. Thus, feedback loops to the respective first, second, and third motors 301, 361, and 370 may be created. Specifically, the first, second, and third motors 301, 361, and 370 may each be communicatively coupled to the control panel 121 through a wired or wireless communication network. Communications may be sent from each of the first, second, and third motors 301, 361, and 370 to the control panel 121 regarding the rotational speed of the each respective agitation unit so that the speed of the respective motors may be adjusted if it is not the same as the input speed. Using these control loops, the revolutions per minute of each agitation unit may be automatically controlled and varied.

The electrical power for all electric motors (such as the first, second, and third motors 301, 361, and 370 and the pump drive 117), instrumentation, electric powered valves, control panels (not shown), communication devices, lights (not shown), and other such electrical apparatuses included in the system 300 is supplied through a generator 118 (not shown in FIG. 3; shown in FIG. 1). The generator 118 may be of several different types including, but not limited to, a rig site generator, a local-skid mounted generator set, and a generator set mounted on a separate modular. Backup power for critical safety systems may be supplied by batteries 140 (shown in FIG. 1).

As shown in FIGS. 1 and 3, the fluid vessel 102 may be coupled to the pump 116 so that fluid may be selectively removed from the fluid vessel 102 as needed at the drill site. The pump 116 may be any pump suitable for transferring highly-viscose sludge and slurries that may have a high concentration of solids. The pump 116 may not require a high net positive suction head (NPSH). Suitable pumps for highly-viscose fluids include, but are not limited to, progressing cavity pumps (PCP), gear pumps, triplex-style plunger pumps, piston pumps, and diaphragm pumps. Pumps that have a minimum pressure pulse or no pressure pulse are preferred for directly transferring fluid from the fluid vessel 102 into a rig drilling fluid pump, cement unit pump, or into a downhole work string. The pump 116 may have valves or be valve-free such as PCP and S-tube piston pumps. As discussed above with respect to FIG. 1, the pump 116 may be coupled to the pump drive 117. The pump drive 117 may be an electric, hydraulic, pneumatic, motor, a reciprocating diesel, gasoline, or natural gas engine, or any other suitable means of power known to those in the art having the benefit of this disclosure. An electric motor drive correctly rated for the area hazards is preferred.

In the embodiment shown in FIG. 3, the pump 116 may be a PCP. The rotational speed output of the pump 116 may be controlled by the pump drive 117. The pump drive 117 may be an electric motor capable of variable speed operation. Therefore, the pump drive 117 may be mechanically or communicatively coupled to the control panel 121. The pump drive 117 may be operable to vary the rotational shaft speed of the pump 116 to control the volumetric discharge rate of a fluid and to control the discharge pressure of the pump 116. A Coriolis mass flow meter 376 may be coupled to the pump 116 and may operate to regulate the flow of fluids being pumped out of the fluid vessel 102. Additionally, a pressure transmitter 377 may be coupled to the pump 116 and may operate to measure and transmit the amount of pressure in a pump discharge pipe 378 through which fluid is being pumped out of the fluid vessel 102. A pressure relief valve 379 may also be coupled to the pump 116. The high-pressure relief valve 379 may operate to reduce pressure in the pump discharge pipe 378. The control panel 121 may receive input from the Coriolis mass flow meter 376 and/or the pressure transmitter 377. Utilizing this control loop, the rotational speed of the pump 116 may be automatically flow-controlled and/or pressure-controlled. Deadhead protection of the pump 116 may be provided by a high-amp switch (not shown) located on a power line to the pump drive 117, the high-pressure relief valve 379, and/or a high-pressure shut-down based on output from the pressure transmitter 377. In addition, a minimum flow indicator 380 may be coupled to the pump 116 to shut down the pump 116 if operated without adequate flow over a pre-set time period.

As shown in FIG. 3, the system 300 may further include the drain valve 115 disposed on the bottom of the fluid vessel 102. A preferred type of drain valve 115 may be a ram/piston design that is resistant to clogging by viscose sludge and slurries. Ram/piston drain valves allow full port discharge when opened, and the valve piston extends into the bottom of the fluid vessel 102 when the drain valve 115 is closed. During the closing operation, the piston serves as a ram that pushes residual fluid from the valve body back into vessel. The pump suction line 382 couples the drain valve 115 to the pump 116 and may be at least four inches in diameter and without constrictions. A minimum net positive suction head (NPSH) at a pump inlet is necessary for a pump to function correctly. In order to maintain adequate NPSH when discharging difficult to handle pills, the pump 116 may create suction at the pump inlet, and the fluid vessel 102 may be pressurized with air to help establish and maintain flow into the pump inlet. A pressure transmitter 381 may be coupled to the pump suction line 382 to verify adequate NPSH when discharging pills from the fluid vessel 102.

The system 300 may be equipped to provide a high turn-down ratio to allow the preparation, storage, and discharge of smaller volume pills without changing out or making major adjustments to equipment. A volumetric turn-down ratio may be defined as the maximum pill volume divided by the minimum pill volume that can be effectively blended, sheared, and mixed using all three agitation units 110, 120, and 130. A system operable to produce a higher turn-down ratio that may be used to prepare, store, and deploy a variety of pills at a drill site during different drilling and completion intervals offers significant advantages. Specifically, this type of system prevents having to change out agitator shafts or move impellers to different locations on the shafts at the drill site. Changing or moving equipment in the fluid vessel 102 at the drill site may require cleaning, isolating, opening, adjusting, and closing the fluid vessel 102. Such activities may require considerable non-productive time, delay operations, contribute to temporary labor storages, increase the volume of waste to dispose of, and increase labor costs.

The three agitation units 110, 120, and 130 may operate before and throughout the discharge process to maximize the recovery of small and/or difficult to handle pills. To achieve the desired turn-down ratio, at least one impeller on each agitation unit may be located in the lower section of the fluid vessel 102. For example, in FIG. 3 impellers 304, 365, and 373 are located in the lower section of the fluid vessel 102 and may stay submerged at lower fluid levels, thus allowing adequate mixing of smaller pills. In some embodiments, and as shown in FIG. 3, the second agitation unit 120 and third agitation unit 130 may include multiple impellers to increase the pill volume turn-down ratio. By installing two impellers each on the second agitation unit 120 and the third agitation unit 130 as illustrated in FIG. 3, a turn-down ratio of up to 6:1 is expected. Thus, the system 300 as shown in the illustrative embodiment of FIG. 3 has a turn-down ratio of up to 6:1. By substituting a conical-shaped vessel bottom for a dished shape vessel bottom, the turn-down ratio may be increased to up to 10:1. A user may vary the size of the fluid vessel 102 in accordance with the desired maximum allowable pill size and practical transportation limitations. Based on practical considerations such as common drilling and completion pill applications, ground transport regulations, and the maximum lifting capacity available at the drill site, the preferred range of maximum allowable pill volume for a single vessel system may range from 15 to 50 barrels of fluid (assuming 42 gallons per barrel of fluid). Based on a 6:1 turndown ratio, a single vessel system with a 50 barrel maximum allowable pill volume may be operated with a minimum pill volume of 8.5 barrels and a single vessel system with a 15 barrel maximum allowable pill volume may be operated with a minimum pill volume of 2.5 barrels. These pill volumes are listed as examples of the flexibility of the systems and methods disclosed herein and are not intended to limit this disclosure. As discussed previously, the fluid vessel 102 may vary in size without departing from the scope of this disclosure.

In the embodiment shown in FIG. 3, the system 300 may be rated for both vacuum and pressurized service. It is advantageous to have vacuum and pressurized service because this service may provide, for example, lower emissions from a closed operating system, lower risk of spills and splashes from a closed operating system, ability to provide the pump 116 with a higher NPSH, ability to apply a partial vacuum to transfer any flowable fluids from rig pits or transport containers into the system 300 instead of using pressure, a higher acceptable temperature range of operation when some solvents, including water, are present, and the ability to apply a partial vacuum while adding powders to the fluid vessel 102 through the funnel 352. The advantages of using a partial vacuum to pull in powders through funnel 352 include less risk of plugging, less risk of back flow, and higher addition rates. Another operational benefit of applying a partial vacuum to the fluid vessel 102 is that materials may be charged into the fluid vessel 102 by sucking out of external containers into fluid line 362, through the valve 363, into the feed line 385, and then into the fluid vessel 102. Transferring flowable materials into the fluid vessel 102 by creating a partial vacuum in the fluid vessel 102 eliminates the need for portable pumps and the associated limitations, set-up time delays, safety hazardous, cleanup, and environmental hazardous of these pumps. For example; materials from drums, pails, Intermediate Bulk Containers (IBC), Iso-tanks, Marine Portable Tanks (MPT), and totes may be transferred out of these containers into the fluid vessel 102 by applying a vacuum instead of setting up portable diaphragm, metering, or centrifugal pumps.

The risk of accidental releases is reduced when negative pressure is applied to the transfer lines or flexible hoses instead of positive pressure when transferring materials. The vent system 390 includes a vent to atmosphere 388, a pressure regulator 386, a line to a compressed air supply 387, which is coupled to the pressure regulator 386, and a line to vacuum system 389. The compressed air supply 387 may supply compressed air to the fluid vessel 102 in order to pressurize the fluid vessel 102. The vent to atmosphere 388 may be engaged in order to change or release the pressure in the fluid vessel 102. The vacuum system 389 may be engaged to create a negative pressure inside the fluid vessel 102.

In order to prepare a variety of pills at the drill site, a broad range of materials such as reactive powders, non-reactive powders, solids, gels, viscose fluids, slurries, sludge, non-volatile fluids, and volatile fluids may be transferred into the fluid vessel 102 from rig pits, other process vessels, rig silos, drums, sacks, totes, intermediate bulk containers, marine portable tanks, ISO-tanks, tank trucks, and other types of transport containers. During filling operations, materials may be pumped, gravity fed through piping, dumped, or sucked into the fluid vessel 102 through the fluid addition line 362, the funnel 352, and the hatch 350 into the fluid vessel 102. Materials may be fed into the fluid vessel 102 as an open system or as a closed system. When adding materials to the fluid vessel 102, the weight of the materials contained in the fluid vessel 102 may be monitored gravimetrically by the strain gauge load cells 114. The strain gauge cells 114 may also be utilized to gravimetrically monitor the weight of pill removed from the fluid vessel 102 during discharge operations. Whether during filling or discharge of the fluid vessel 102, the capability to monitor changes in vessel content weight is advantageous. Direct gravimetric measurement is particularly advantageous when operating a closed system.

In certain embodiments, the system 300 may be equipped for use in a cool climate and thus may be insulated or insulated and heated (not shown in FIG. 3). A rapid increase in viscosity as temperature decreases is a common property for many pill formulations. As the fluid temperature drops, the pill may transition into a gel or semisolid fluid that may be very difficult to handle. In addition, pills formulated with water as a major component are common when the drilling fluid at the drill site is a water-based mud (WBM) or when the drilling operation switches to completion brines. Lower ambient temperatures tend to cool pills over time and may eventually cause processing and handling problems associated with high viscosities, salt precipitation, or freezing unless insulation and/or heating is employed. Therefore; some pills cannot be built, stored, and deployed unless the fluid is kept at or above a minimum temperature. An insulated and heated system may include one or more of the following components: an insulating material coupled to the fluid vessel 102, a heat transfer fluid, a heat transfer device in fluid communication with the fluid vessel 102, a heat supply coupled to the heat transfer device, and a temperature sensor 346 coupled to the fluid vessel 102. The heat transfer device may include, but is not limited to, a fuel burner or an electric heater. The heat transfer device may include any combination of the following: one or more external jackets, one or more external coils, tracing, and one or more internal coils. The heat transfer device may be coupled to the fluid vessel 102 by one or more lines and/or vessels. The lines and vessels may be traced with electric elements or heat transfer fluid tubes. The heat transfer fluid may be circulated through the coils, jackets, and tracing tubes. The heat transfer fluid may be a treated fresh water solution referred to as tempered water, a brine, or oil. The composition of tempered water may contain an antifreeze and/or one or more micro-biocides. In some embodiments, a steam vapor may be used as the heat transfer fluid. The desired physical properties of an oil-based heat transfer fluid may include low viscosity and low vapor pressure. The piping systems, nozzles, and vessels may also be insulated. These types of insulation systems are known to those with skill in the art having the benefit of this disclosure.

In certain embodiments, the system 300 may include a variety of other connections and features, which are not shown in FIG. 3 for the sake of clarity. For example, the system 300 may include a chain hoist or a hydraulic lift system coupled to the top head (not shown) of the fluid vessel 102. Such a system may allow for the rapid removal of the top head for quick clean-out between pill batches or may allow for the changing out of vessel internal components such as impellers.

Further, it may be advantageous to couple two or more modular fluid vessels together into an integrated system for preparing, storing, and/or deploying multiple pills. Turning now to FIG. 4, a front view of a mobile three-vessel integrated system for preparing, storing, and/or deploying pills in accordance with an illustrative embodiment of the present disclosure is denoted generally with reference number 400. The system 400 includes vessel bays 402a, 402b, and 402c. Modular vessel skids 404a, 404b, and 404c may be mounted on the vessel bays 402a, b, c. The modular vessel skids 404a, b, c may include fork truck slots and crane lift eyes for safe lifting. Fluid vessels 406a, b, c, may be mounted on the vessel skids 404a, b, c. For multiple vessel integrated systems, the fluid vessels 406a, b, c may be of different sizes, shapes, and configurations. In some embodiments, each fluid vessel 406a, b, c may be used for a different purpose. For example, pills may be prepared in fluid vessel 406b, transferred to fluid vessel 406a for storage, and transferred back to fluid vessel 406b for destruction of all gelled globular particles before being pumped downhole. The system 400 also includes a work deck 407 positioned adjacent to the vessel bays, a pump and power bay 408 that may be positioned below the work deck 407 adjacent to the vessel skids 404a, b, c, and a safe access ladder 409 coupled to the work deck 407. The vessel skids 404a, 404b, and 404c and the pump and power skid (not shown in FIG. 4) may each be coupled to the rack skid 410. The rack skid 410 may be configured to accommodate combinations of various types of fluid vessels 406a, b, c that may conform to the dimensions of the vessel bays 402a, b, c thus providing flexibility in terms of capabilities and cost. The three modular vessel skids 404a, b, c, the rack skid 410, and the pump and power skid (not shown) included in the system 400 may be transported to the drill site separately or in any combination that road weight regulations and available lift equipment weight limitations allow. Once at the drill site, the rack skid 410 allows the components of the system 400 to be arranged such that deck space or ground space requirements are minimized. Two or more rack skids 410 of various functionalities may be coupled and stacked to form an integrated system that minimizes the ground or deck space occupied. For example, the system 400 may be expanded into a six-vessel integrated system by stacking two rack skids 410. The stacked skid configuration may be operated as one integrated system and does not require additional drill site deck or ground space. The modular skid systems may be an integral part of an overall pill delivery system and may increase the value of such systems at the rig site by increasing the overall number of pills and pill volumes that can be prepared, stored, and deployed. For certain operations such as displacements, prepared and stored spacer pills may be rapidly deployed downhole in succession without interrupting the circulation of the wellbore.

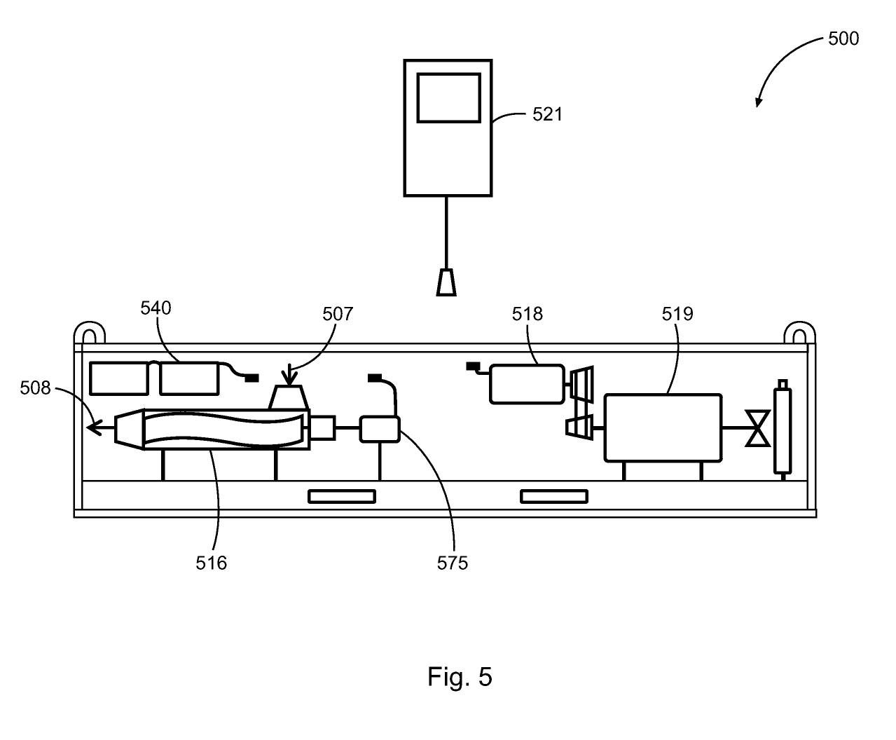

Turning now to FIG. 5, a mobile power and pump skid for preparing, storing, and/or deploying pills in accordance with an illustrative embodiment of the present disclosure is denoted generally with reference number 500. The system 500 may include a pump 516. The pump 516 may be specified for high viscosity fluids. A pump drive 575 may be coupled to the pump 516. The pump drive 575 may be specified for variable speed and hazardous locations. The pump drive 575 may be any suitable pump including, but not limited to, an electric pump drive. A generator 518 may provide power to the pump drive 575 and to the agitation units shown in FIGS. 1 and 3. The generator 518 may be coupled to a reciprocating engine 519. The generator 518 and reciprocating engine 519 may be specified for hazardous locations. The generator 518 may be sized to meet all anticipated loads and provide 230 volt, 3 phase power. The reciprocating engine 519 may be diesel, gasoline, natural gas, or dual fuel. The batteries 540 may be coupled to and designed for starting reciprocating engine 519 and providing critical uninterruptable power. A control panel 521 may be communicatively coupled to the pump drive 575 and the generator 518. The control panel 521 may be housed with monitoring screens and a VFD in some embodiments. The control panel 521 may house all electrical components that are not rated for hazardous locations or need protection from the environment. The pump 516 may provide several different types of transfers, including fluids between skid vessel, pills to drilling operations, and waste fluids to containers or discharge points. The system 500 may be configured and specified for lifting by fork truck and crane, transport by land and marine, operation on land and offshore, and to be placed into a rack skid as part of an integrated system. The pump 516 may be coupled to a first transfer line 507 and a second transfer line 508. The first transfer line 507 provides fluid communication between the suction of pump 516 and the fluid vessel (not shown). The second transfer line 508 provides fluid communication between the discharge of pump 516 and drill site operations (not shown). The system 500 may be configured to allow integrated pill preparation, storage, and deployment systems with minimum reliance on rig personnel and utilities.

### EXAMPLE 1

The following example is included to help illustrate the present disclosure.

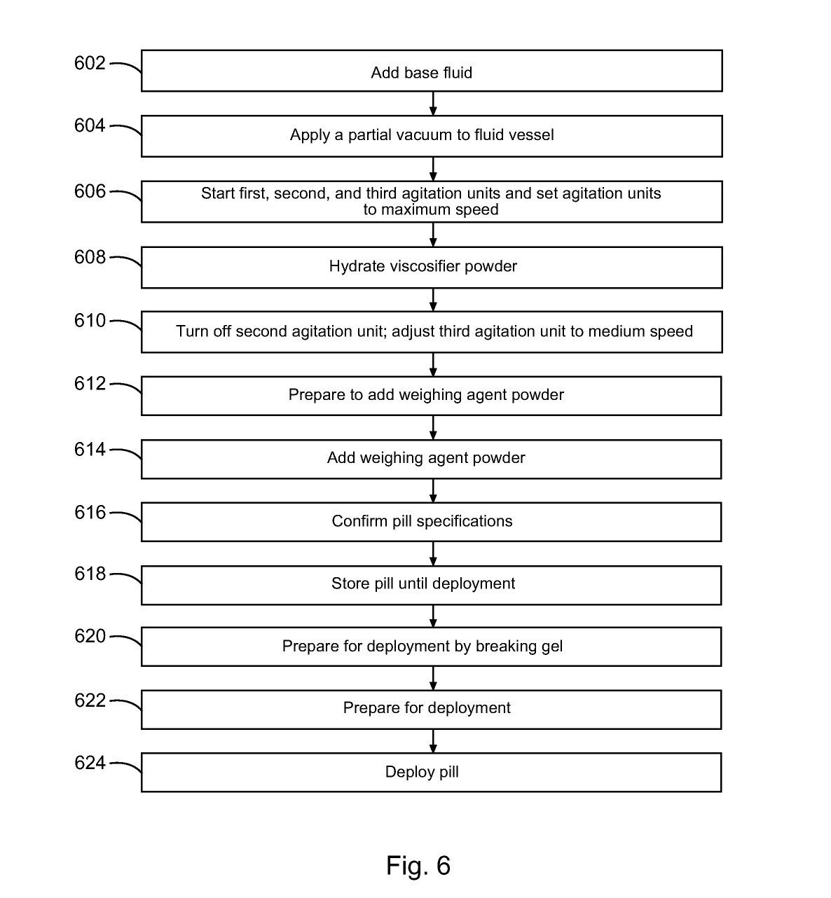

A barrier fluid pill may be prepared for tripping out of wellbore during managed pressure drilling operations. Once placed in the wellbore under static conditions, the purpose of the barrier pill is to prevent a higher density mud cap that may be placed in an upper portion of the wellbore from mixing with the less dense drilling fluid in a lower portion of the wellbore. This highly thixotropic pill may be prepared, stored, and deployed by following the given step sequence as shown in FIG. 6 using a single vessel process apparatus as depicted in FIG. 3. Turning now to FIG. 6; sequential steps for preparing, storing, and/or deploying a pill in accordance with illustrative embodiment of the present disclosure are shown, and references are made to the system 300 depicted in FIG. 3. At step 602, fresh water may be added to the fluid vessel 102 through the fluid addition line 362 at atmospheric pressure until a desired fluid weight set point is detected by the load cells 114. After proper isolation of the fluid vessel 102 from the atmosphere, a partial vacuum is applied and controlled by the vacuum system 389 at step 604. At step 606, the first agitation unit 110, the second agitation unit 120, and the third agitation unit 130 are started and set to maximum rotational speed settings to create high-intensity triple action mixing. At step 608, a powder additive used to create viscosity and suspension capability may be added to the fluid vessel 102 through the funnel 352 by opening valve 353 and transferring through line 384. The funnel valve 353 may then be closed, followed by continuation of high-intensity mixing for approximately an additional 20 minutes to insure complete hydration of the powder additive. At step 610, the second agitation unit 120 may be turned off, the third agitation unit 130 may be adjusted to a medium speed, and the first agitation unit 110 may remain on high speed. At step 612, the partial vacuum may be broken through the vent line 388 and atmosphere pressure inside of the fluid vessel 102 is confirmed by the pressure transmitter 342. At step 614, the hatch 350 is opened, desired fluid viscosity is confirmed, and barite powder is added until the fluid density specification is reached. At step 616, a sample of the thixotropic pill is withdrawn through the hatch 350 and quality control analysis as related to density and rheological properties are performed. At step 618, all three agitation units 110, 120, 130 are turned off or confirmed turned off, the hatch 350 is closed, the finished highly thixotropic pill is allowed to form a strong semisolid gelled mass, and the finished pill is stored in the fluid vessel 102 until needed. At step 620, to prepare for deployment by breaking gel, the hatch 350 is opened, the fluid gel structure is broken by soft starting the first agitation unit 110 and the third agitation unit 130 and adjusting both of these agitation units to medium speed. At step 622, to prepare for deployment, hatch 350 may be closed, air may be added from the compressed air system 387 to pressurize the fluid vessel 102, and the second agitation unit 120 may be turned on at medium speed. The vessel discharge pump 116 and the transfer lines 382 and 378 may be prepared. At step 624, to deploy the pill, the first, second, and third agitation units 110, 120, and 130 are adjusted to maximum speed. The bottom vessel discharge valve 115 may be opened, the vessel discharge pump 116 may be turned on, and the speed of the discharge pump 116 may be adjusted. The desired pill volume transferred by monitoring load cells 114 may be confirmed. Then, the vessel discharge pump 116 may be shut down, the bottom discharge valve 115 may be closed, and the first, second, and third agitation units 110, 120, and 130 may be turned off. Finally, the vent to atmosphere 388 may be opened to relieve pressure from the fluid vessel 102, and the hatch 350 may be opened.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A system for preparation, storage, and/or deployment of a specialized fluid, comprising:
a fluid vessel;
a first agitation unit, a second agitation unit and a third agitation unit, wherein each of the first agitation unit, the second agitation unit and the third agitation unit is at least partially disposed within the fluid vessel;
a first motor, a second motor, and a third motor coupled to the first agitation unit, the second agitation unit, and the third agitation unit, respectively, wherein the first motor, second motor, and third motor are independently operable.

2. The system of claim 1, further comprising:
a vessel skid coupled to the fluid vessel, wherein the fluid vessel is couplable to the vessel skid.

3. The system of claim 1, further comprising:
a vacuum system coupled to the fluid vessel; and
a compressed air supply coupled to the fluid vessel, wherein the compressed air supply may be engaged to pressurize the fluid vessel, and wherein the vacuum system may be engaged to create a negative pressure inside the fluid vessel.

4. The system of claim 1, wherein the fluid vessel is transportable to a drill site.

5. The system of claim 1, wherein the system has a turn-down ratio of up to 10:1.

6. The system of claim 1, wherein the first, second, and third agitation units may be operated at variable speeds.

7. The system of claim 1, wherein the first, second, and third agitation units each comprise:
a shaft coupler, and
an impeller coupled to the shaft coupler.

8. The system of claim 1, further comprising:
a heat transfer device in fluid communication with the fluid vessel,
a heat supply coupled to the heat transfer device, and
a temperature sensor coupled to the fluid vessel, wherein the temperature sensor monitors the temperature inside the fluid vessel.

9. The system of claim 1, further comprising:
an insulating material coupled to the fluid vessel.

10. The system of claim 1, further comprising:
a drain valve disposed within the fluid vessel; and
a pump coupled to the fluid vessel.

11. A method for preparing, storing, and/or deploying one or more specialized fluids, comprising:
mixing a first specialized fluid in a first fluid vessel using any combination of a first agitation unit, a second agitation unit, and a third agitation unit; and
removing the first specialized fluid from the first fluid vessel.

12. The method of claim 11, further comprising:
mixing a second specialized fluid in a second fluid vessel using any combination of a first agitation unit, a second agitation unit, and a third agitation unit; and
removing the second specialized fluid from the second fluid vessel immediately after removing the first specialized fluid from the first fluid vessel.

13. The method of claim 11, further comprising:
applying a vacuum to the first fluid vessel; and
creating pressure in the first fluid vessel by supplying compressed air to the first fluid vessel.

14. The method of claim 11, further comprising:
transporting the first fluid vessel to a drill site.

15. The method of claim 11, further comprising:
varying the operation speed of at least one of the first, second, and third agitation units.

16. The method of claim 11, further comprising:
transferring heat to the first specialized fluid in the first fluid vessel.

17. The method of claim 11, further comprising:
insulating the first fluid vessel.
